(19) United States
(12) Patent Application Publication
(10) Pub. No.: US 2010/0226122 A1
(43) Pub. Date: Sep. 9, 2010

(54) Light Wave Type Insect Repellent Device

(76) Inventors: Shang-Chieh Tsai, Sihu Township (TW); Tsung-Te Hsu, Beigang Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/396,535

(22) Filed: Mar. 3, 2009

(51) Int. Cl. F21V 9/00

(52) U.S. Cl. 362/231

(57) ABSTRACT

A light wave type insect repellent device is set up in an area where various crops are grown and comprises a plurality of lamps each having a plurality of light emitting elements and a power source, each lamp comprises a socket with a flash IC, each of the light emitting elements is connected to the flash IC by a power cable and generates yellow and orange flash light, each socket is covered with a cover which is provided with a plurality of through holes through which each light emitting light is protruded out of the cover to generate light to repel harmful insects day and night.

### BACKGROUND OF THE INVENTION

1. Field of the Invention

The present invention relates to a light wave type insect repellent device, and more particularly to an environmentally friendly and insecticide free insect repellent device which is capable of effectively restraining insects' reproduction by preventing the harmful or noontide insects from entering the crops grown area to eat the crops or lay eggs.

2. Description of the Prior Art

At present, there are usually two methods to prevent harmful or noontide insects from entering the large-scale crop (leafy vegetables for example) growing area and laying eggs on the leafy vegetable, otherwise, the harmful insects or the future larvae of the noontide insects will eat the vegetables. One method is to enclose the area where leafy vegetables are grown with light transmittance net, and this method is relatively cost intensive. The other method is to spray insecticide on the crops (the leafy vegetables) when they are young, however, the insecticide will remain on the vegetables even after they grow up and do a lot of harm to eater's health. Hence, people have been trying to kill the harmful or noontide insects in an environmentally friendly way, but have met limited success.

The present invention has arisen to mitigate and/or obviate the afore-described disadvantages.

### SUMMARY OF THE INVENTION

Aimed at the abovementioned problems, the present invention provides an environmentally friendly light wave type insect repellent device which is insecticide free and capable of effectively restraining insects' reproduction by preventing the harmful insects during daytime or noontide insects at night from entering the crops grown area to eat the crops or lay eggs.

The primary object of the present invention is to provide a light wave type insect repellent device which is set up in an area where various crops are grown and comprises a plurality of lamps each having a plurality of light emitting elements and a power source, each lamp comprises a socket with a flash IC, each of the light emitting elements is connected to the flash IC by a power cable and generates yellow and orange flash light, each socket is covered with a cover which is provided with a plurality of through holes through which each light emitting light is protruded out of the cover to generate light to repel harmful insects day and night.

The secondary object of the present invention is to provide a light wave type insect repellent device, wherein a wave length of the yellow light generated by each of the light emitting elements is 550˜585 nm.

The third object of the present invention is to provide a light wave type insect repellent device, wherein a wave length of the orange light generated by each of the light emitting elements is 585˜620 nm.

The fourth object of the present invention is to provide a light wave type insect repellent device, wherein each light emitting element flashes three times per second to produce yellow and orange mixed light.

The fifth object of the present invention is to provide a light wave type insect repellent device, wherein a power-on time of each light emitting element is less than 0.1 second each time.

The sixth object of the present invention is to provide a light wave type insect repellent device, wherein the yellow and orange mixed light of each lamp is above 4000 LUX (luminous flux).

The seventh object of the present invention is to provide a light wave type insect repellent device, wherein a light intensity of the yellow and orange mixed light generated by each light emitting light of the each lamp is above 400 lm (luminosity) or 40 cd (candle).

The eighth object of the present invention is to provide a light wave type insect repellent device, wherein the lamps are arranged in a staggered manner to provide a better insect repellent effect.

The ninth object of the present invention is to provide a light wave type insect repellent device, wherein a radius of illumination is more than 4 m, each of the lamps is disposed 1-1.5 m above the crops.

The tenth object of the present invention is to provide a light wave type insect repellent device, wherein each of the lamps is connected to a power source by a plug of a transformer.

The eleventh object of the present invention is to provide a light wave type insect repellent device, wherein each of the lamps is connected to a battery.

### BRIEF DESCRIPTION OF THE DRAWINGS

FIG. 1 is a perspective view of a lamp and a power source in accordance with the present invention;

FIG. 2 is an exploded view of the lamp in accordance with the present invention;

FIG. 3 is a top view of the lamp in accordance with the present invention;

FIG. 4 is a cross sectional view taken along the line 30-30 of FIG. 3;

FIG. 5 shows a light wave type insect repellent device in accordance with the present invention is set up in an area where various crops are grown; and

FIG. 5A is an enlarged view of the light wave type insect repellent device which is set up in an area where various crops are grown.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

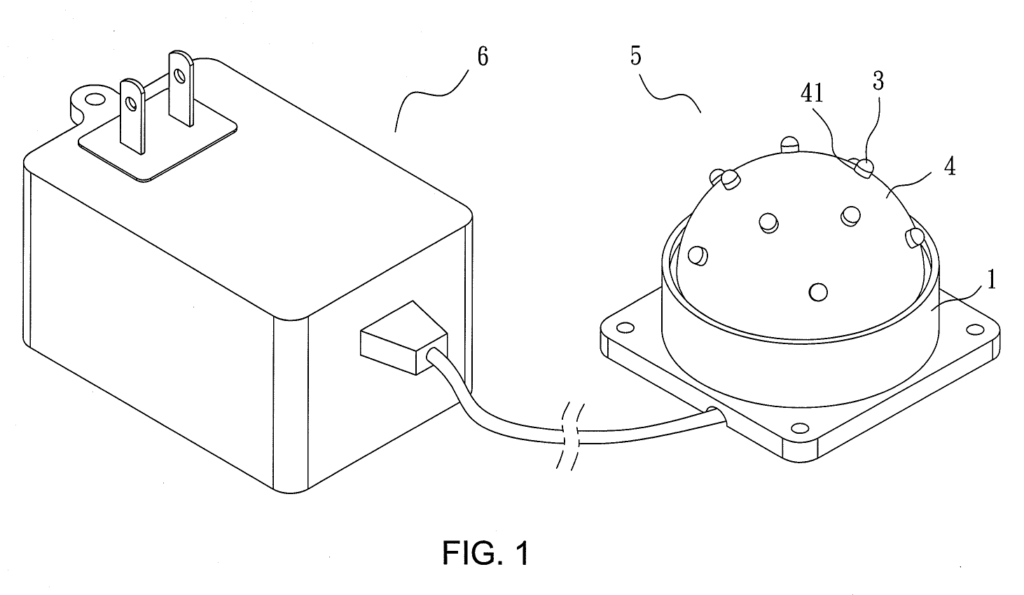

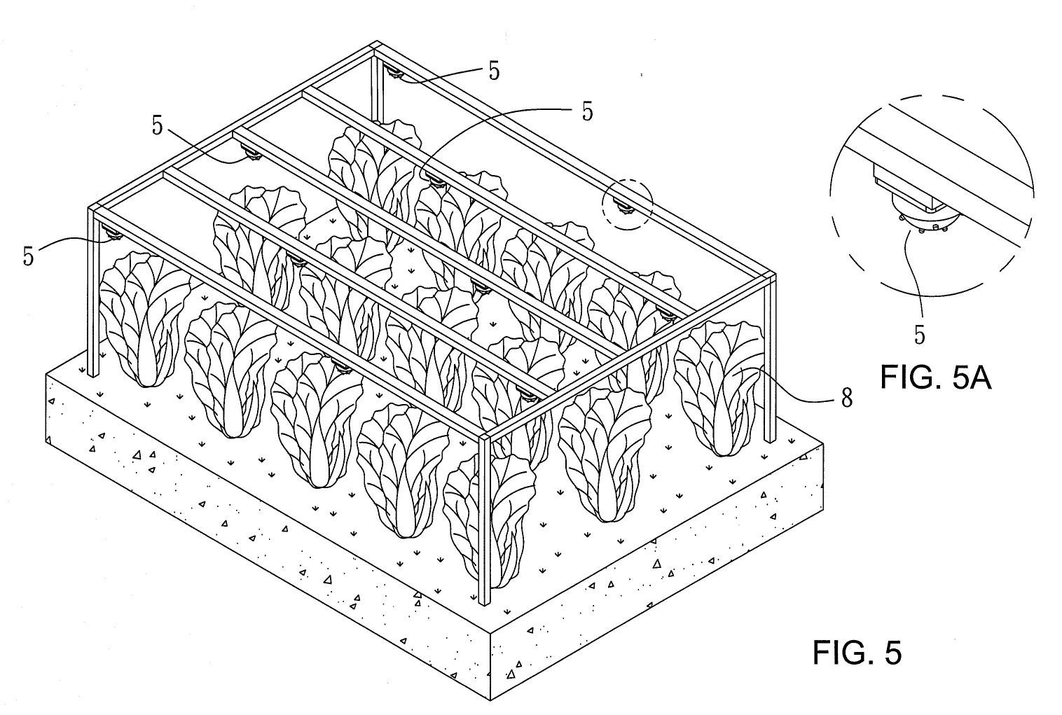

Referring to FIGS. 5 and 5A, a light wave type insect repellent device 7 in accordance with the present invention is set up in an area where various crops 8 are grown and comprises a plurality of lamps 5 each having a plurality of light emitting elements 3 and a power source 6, as shown in FIG. 1.

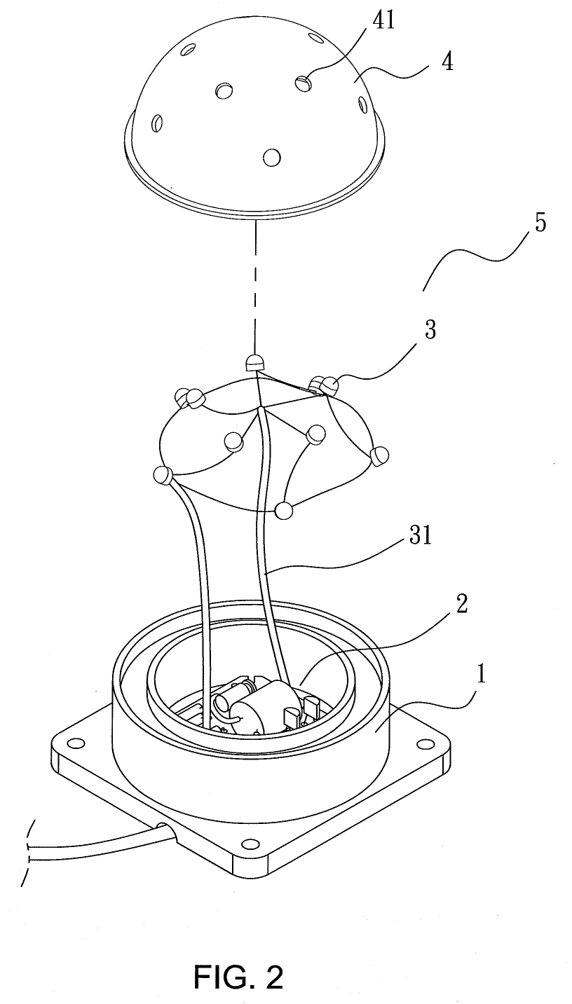

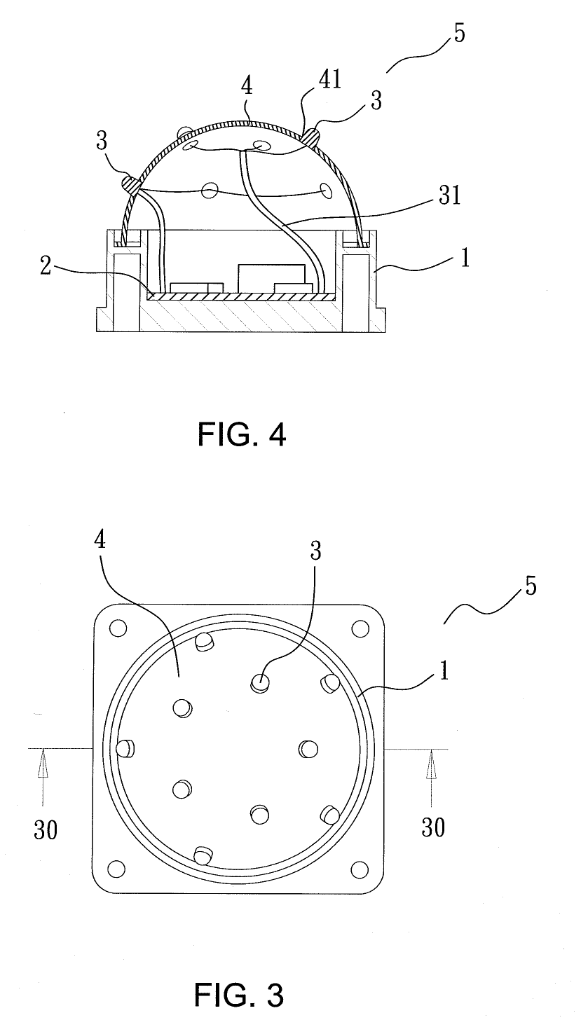

Each lamp 5, as shown in FIG. 2, comprises a socket 1 with a flash IC (integrated circuit board) 2, each of the light emitting elements 3 is connected to the flash IC 2 by a power cable 31 and generates yellow and orange flash light. The wave length of the yellow light is preferably 550˜585 nm and that of the orange light is preferably 585˜620 nm. Each light emitting element 3 flashes three times per second to produce yellow and orange mixed light, the power-on time of each light emitting element 3 is preferably less than 0.1 second each time, and the light of each lamp 5 is preferably above 4000 LUX (luminous flux), and the light intensity of the yellow and orange mixed light generated by each light emitting light 3 of the each lamp 5 is preferably above 400 lm (luminosity) or 40 cd (candle). Each socket 1 is covered with a cover 4 which is provided with a plurality of through holes 41 through which each light emitting light 3 is protruded out of the cover 4 (as shown in FIGS. 3 and 4), so as to form a lamp 5.

The power source 6, as shown in FIG. 1, serves to supply power to the respective lamps 5 (in this embodiment, the power source 6 is connected to a power source by a plug of a power transformer, or it can also be connected to a battery).

As shown in FIGS. 5 and 5A, the lamps 5 are arranged in a plant area wherein various crops 8 are grown in a staggered manner such that the radius of rumination is preferably more than 4 m, each of the lamps 5 is disposed 1-1.5 m above the crops 8, and the lamps are connected in series to the power source, so as to form a light wave type insect repellent device 7. After being turned on, each of the light emitting elements 3 of the respective lamps 5 of the light wave type insect repellent device 7 will produce yellow and orange flash light to repel the insects day and night (During the wintertime in Taiwan, the lamp 5 is preferably turned on during 5:00-8:30, 11:00-13:00, 16:00-18:30; otherwise, during the summertime in Taiwan, the repellent device is preferably turned on during 4:00-8:30, 11:00-13:00, 17:30-20:30, such that the lamp 5 will not be turned on all the time to repel beneficial insects). When their photosensitive organ receive the light, the harmful insects will feel faint and even become blind, as a result, the insects will run away or starve to death, thus preventing the harmful or noontide insects from entering the crops grown area to eat the crops or lay eggs, effectively restraining insects' reproduction. Hence, the present invention is environmentally friendly without the use of insecticide.

While we have shown and described various embodiments in accordance with the present invention, it is clear to those skilled in the art that further embodiments may be made without departing from the scope of the present invention.

What is claimed is:

1. A light wave type insect repellent device set up in an area where various crops are grown and comprising a plurality of lamps each having a plurality of light emitting elements and a power source, each lamp comprising a socket with a flash integrated circuit board, each of the light emitting elements being connected to the flash integrated circuit board by a power cable and generating yellow and orange mixed flash light, each socket being covered with a cover which is provided with a plurality of through holes through which each light emitting light is protruded out of the cover to generate light to repel harmful insects day and night.

2. The light wave type insect repellent device as claimed in claim 1, wherein a wave length of the yellow light generated by each of the light emitting elements is 550˜585 nm.

3. The light wave type insect repellent device as claimed in claim 1, wherein a wave length of the orange light generated by each of the light emitting elements is 585˜620 nm.

4. The light wave type insect repellent device as claimed in claim 1, wherein each light emitting element flashes three times per second to produce yellow and orange mixed light.

5. The light wave type insect repellent device as claimed in claim 1, wherein a power-on time of each light emitting element is less than 0.1 second each time.

6. The light wave type insect repellent device as claimed in claim 1, wherein the yellow and orange mixed light of each lamp is above 4000 luminous flux.

7. The light wave type insect repellent device as claimed in claim 1, wherein a light intensity of the yellow and orange mixed light generated by each light emitting light of the each lamp is above 400 lm or 40 cd.

8. The light wave type insect repellent device as claimed in claim 1, wherein the lamps are arranged in a staggered manner to provide a better insect repellent effect.

9. The light wave type insect repellent device as claimed in claim 1, wherein a radius of illumination is more than 4 m, each of the lamps is disposed 1-1.5 m above the crops.

10. The light wave type insect repellent device as claimed in claim 1, wherein each of the lamps is connected to a power source by a plug of a transformer.

11. The light wave type insect repellent device as claimed in claim 1, wherein each of the lamps is connected to a battery.
